(19) United States
(12) Patent Application Publication
(10) Pub. No.: US 2006/0018985 A1
(43) Pub. Date: Jan. 26, 2006

(54) Ant away

(76) Inventor: Brady James Nash, Las Vegas, NV (US)

Correspondence Address: Brady James Nash, 4955 Lindell Rd. Apt. 113, Las Vegas, NV, 89118, US

(21) Appl. No.: 10/298,199

(22) Filed: Nov. 18, 2002

(51) Int. Cl. A01N 65/00; A01N 25/00

(52) U.S. Cl. 424/769; 424/405

(57) ABSTRACT

“Ant Away” is made from a petri dish that contains three (3) grams of dried bay leaves. When placed in dwellings, the object of this product will be to deter ants from dwellings. The aroma from the dried bay leaves will permeate through the ⅛″ holes drilled on the lid of the dish. This aroma will deter ants from entering or inhabiting dwellings.

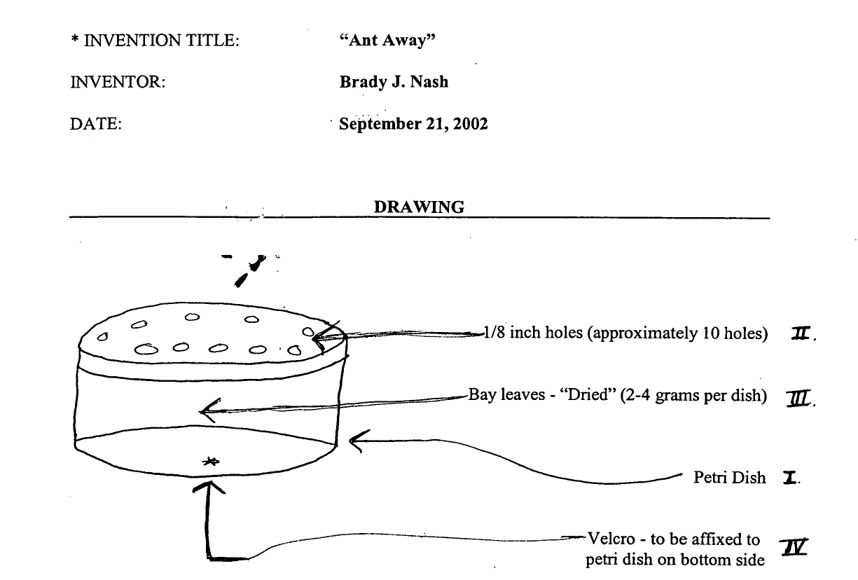

This product will be used to repel ants from invading dwellings. Use three or four petri dishes (I) containing dried bay leaves (III) and place them in a dwelling where ants may invade. Secure the petri dishes in place with a one inch (1″) piece of velcro (IV).

Petri dishes should have approximately 10⅛″ holes (II) drilled into the lid to allow bay leaf aroma to escape. This will repel ants from inhabiting or invading the dwelling. Please refer to drawing.

1. What I claim as my invention is that the aroma emitted from the bay leaves inside the petri dish will deter ants from entering or from inhabiting dwellings.
